(19) United States
(12) Patent Application Publication
(10) Pub. No.: US 2015/0205221 A1
(43) Pub. Date: Jul. 23, 2015

(54) Liquid Toner Dispersion and Use Thereof

(71) Applicant: Xeikon IP BV, Eede (NL)

(72) Inventors: Geert Gaston Paul Deroover, Lier (BE); Lode Erik Dries Deprez, Wachtebeke (BE); Werner Jozef Johan Op de Beeck, Putte (BE)

(21) Appl. No.: 14/594,308

(22) Filed: Jan. 12, 2015

(30) Foreign Application Priority Data
Jan. 21, 2014 (NL) 2012115

(51) Int. Cl. G03G 9/00

(52) U.S. Cl. CPC G03G 9/132; G03G 15/104; G03G 9/12

(57) ABSTRACT

The liquid toner dispersion comprises marking particles to which dispersing agent is bound for dispersing the marking particles in a substantially non-polar carrier liquid. The dispersing agent is of a hyper-dispersant type comprising an anchor group for binding to a marking particle and stabilizing groups coupled to the anchor group for stabilizing said marking particle in the carrier liquid. The dispersion further comprises a spacer agent that comprises a polar head group and a substantially non-polar tail, and that acts as a spacer of the marking particles.

### CROSS-REFERENCE TO RELATED APPLICATION

This application claims priority to The Netherlands Patent Application No. 2012115 filed Jan. 21, 2014, the disclosure of which is hereby incorporated in its entirety by reference.

### FIELD OF THE INVENTION

The invention relates to a liquid toner dispersion and the use thereof.

The invention further relates to a method of digitally printing comprising the steps of:
transferring a liquid toner dispersion image-wise from a first member via at least one further member to a substrate, which transferred image substantially corresponds to an image to be printed on the substrate, wherein excess liquid toner dispersion remains present on the first member after said image-wise transfer, and
removing, at least substantially, the excess liquid toner dispersion from the first member.

### BACKGROUND OF THE INVENTION

Digital printing apparatus using liquid development dispersion—also known as liquid toner—are known from US patent application publication no. 2011/0249990. The known digital printing apparatus comprises a feed roller, a toner roller, toner roller cleaning means, and an image carrying roller; the feed roller being arranged to transfer a quantity of liquid toner from a reservoir onto the toner roller; and the toner roller being arranged to transfer a portion of the quantity of liquid toner onto the image carrying roller in accordance with a charge pattern sustained on a surface of said image carrying roller. A liquid toner residue, also referred to as an excess liquid toner dispersion, remains on (the surface of) the toner roller after the image-wise transfer of the liquid toner from the development roller to a further roller, particularly the imaging roller.

In digital printing systems of this kind, it is necessary to remove the liquid toner residue that remains on the surface of the toner roller after contact with the imaging roller. Any liquid toner residue that remains on the surface of the imaging roller after contact with a transfer roller of after contact with a substrate needs to be removed as well. More generally, it may be desirable to remove a residue remaining on any roller of the apparatus. It is observed that these highly concentrated and therefore highly viscous compacted toners are not easily de-compacted and removed from rollers. Thus, the removal of such a residue can be quite challenging.

Particularly, marking particles in the liquid toner dispersion tend to form lumps in the dispersion resulting in a liquid with a non-uniform distribution of marking particles. This is called caking and often results in an increase of the viscosity of the liquid dispersion. This viscosity increase is significant and could be a tenfold increase or even more.

Liquid toner dispersion that shows caking cannot be used for printing as such and needs to be treated first in order to re-obtain a homogeneously dispersed liquid toner which has similar conductivity and viscosity properties as the starting liquid toner dispersion.

It is thought that caking is the result of marking particles that come so close into each other's neighbourhood on the developing member, so that they start to feel each other's presence and start interacting with each other. Caking can also be the result of injecting charge and applying high shearing forces which are typically present when a thin layer of liquid toner dispersion passes through a very narrow gap between two (rotating) members of the printing apparatus or huge (micro-sized) mechanical interaction like a cleaning blade scraping on a rotating surface.

The removal of the liquid toner residue starts then to be problematic. As a result, liquid toner residue could remain on the development roller, which constitutes a contamination and may lead to a non-uniform distribution of fresh toner dispersion resulting in a ghost image, density fluctuations and or image quality that is not perfect, in other words incorrect. Specific examples of issues are density instability and incorrect reproduction of fine lines. Removal of the toner residue by a removal device may reduce the issue, but is known to solve the issue incompletely. It is therefore a major problem to solve the caking issue, without giving rise to a reduced printing quality.

### SUMMARY OF THE INVENTION

According to a first aspect of the invention, a liquid toner dispersion is provided that comprises marking particles to which dispersing agent is bound for dispersing said marking particles in a substantially non-polar carrier liquid, which dispersing agent is of a hyper-dispersant type comprising an anchor group for binding to a marking particle and stabilising groups coupled to said anchor group for stabilising said marking particle in the carrier liquid, wherein the dispersion further comprises a spacer agent that comprises a polar head group and a substantially non-polar tail, and that acts as a spacer of the marking particles, wherein the spacer agent has a molecular weight of at least 800 g/mol, preferably at least 1000 g/mol.

According to a second aspect, the invention provides a method of digitally printing that comprises the steps of:
charging a liquid toner dispersion comprising marking particles to which dispersing agent is bound for dispersing said marking particles in a substantially non-polar carrier liquid, which dispersing agent is of a hyper-dispersant type comprising an anchor group for binding to a marking particle and stabilising groups coupled to said anchor group for stabilising said marking particle in the carrier liquid;
transferring the charged liquid toner dispersion image-wise from a first member optionally via at least one further member to a substrate,
removing, at least substantially, the excess liquid toner dispersion from the first member,
   wherein a spacer agent is present that comprises a polar head group and a substantially non-polar tail, and that acts as a spacer of the marking particles, and wherein the spacer agent has a molecular weight of at least 800 g/mol, preferably at least 1.000 g/mol.

According to a third aspect, the invention relates to the use of a spacer agent comprising a polar head group and a substantially non-polar tail and a molecular weight of at least 800 g/mol, preferably at least 1.000 g/mol in a liquid toner dispersion of marking particles in a carrier liquid for use in a printing process based on selective, image-wise transfer from a first member via a further member to a substrate, wherein said spacer agent acts in spacing apart marking particles of the liquid toner dispersion, being present on the first member, after being made subject to charging and after the image-wise transfer of the liquid toner dispersion from the first member.

In accordance with the invention, an additive has been found that does not disturb the printing process (charging, transfer and fusing), but reduces caking and/or enhances the removal of the excess liquid toner dispersion from the first member. This additive is a spacer agent with a polar head group and a substantially non-polar tail, and a sufficient molar mass. As a consequence, the spacer agent has an affinity for both the carrier liquid, so as to get dissolved therein, but also for stabilising groups and anchoring groups of the dispersing agent or in some part to the toner surface itself. Said affinity for said stabilising groups suitably results in an interaction between the spacer agent and the stabilising and or anchoring groups. Such interaction may be based on bonding, but alternatively can be a physical interaction by means of Van der Waals forces or hydrogen bond interactions. The interaction between the polar head group and the dispersing agent is more specifically believed to be based on acid-base interaction, optionally in the form of a reaction such as ring opening of the spacer agent and/or breaking of an ester function with attack of an amine-site of the dispersing agent. It is believed by the inventors that the interaction in some cases is reversible, such that the spacer agent may be desorbed or detached from the dispersing agent which is beneficial during fusing.

More preferably the chemical structure of the spacer agent and the stabilising group is similar or identical, and more particularly on the basis of a polymer with carbon-based chains and one or more polar linking groups—one of which being or being part of the head group—so as to allow conformational alignment. In this manner, the stabilising group of the dispersing agent is effectively extended or the number of stabilising groups is increased. Key is however the macroscopically found improvement rather than the microscopic mechanism.

Surprisingly, the addition of the spacer agent does neither have a negative impact on the fusing behaviour of the liquid toner dispersion nor on the charging of the toner. As a consequence, both film forming properties and image quality of the resulting print is not, or at least not substantially, degraded. The combination of dispersing agent and spacer agent herein appears to provide a behaviour that is distinct from a dispersing agent with longer and or higher number of stabilising groups.

Thus, the liquid toner dispersion of the invention comprises a spacer agent that is different from a dispersing agent and which spacer agent primarily comprises stabilising moieties, such as used in the dispersing agent, however without any anchoring group. The stabilising moieties of the spacer agent can therefore interact with the stabilising and anchoring moieties of the dispersing agent. It is believed by the inventors that this interaction results in creating less attraction between the marking particles by elongation of the existing tails (stabilising groups) of the dispersing agent (‘DA-tails’), by creating inter-tail distortion by other conformational structures or by increasing the number of DA-tails without influencing the charging and/or fusing.

The term ‘substantially non-polar’ refers in the context of the present invention to a chemical entity that is overall non-polar even though it may contain some polarisable groups such as ester, hydroxyl and/or carboxyl groups. The substantially non-polar carrier liquid is suitably selected from the group consisting of a mineral oil, a low or high viscosity liquid paraffin, isoparaffinic hydrocarbons (linear or branched) a fatty acid glyceride, a vegetable oil and any combination thereof. Typical commercially available carrier liquids are Isopar L, Isopar M and Isopar V and higher boiling point Isopars from Exxon, white mineral oils from Sonneborn Inc., Paraffin oils of Petro Canada and vegetable oils from Cargill.

The term ‘polar head group’ refers in the context of the invention to a chemical group that is polar, particularly in comparison to the non-polar tail. The polar head group differs from the anchor group of the dispersing agent in that it is essentially a single functional group (single site) rather than a molecule with several binding sites. Suitable examples of polar head groups are acids, such as carboxylic acids, sulphonic acids, anhydrides, such as succinic anhydride and amides. Suitably examples of anchor groups of the dispersing agent are amine-functionalized polymers, such as polyalkyleneimines, for instance polyethyleneimine (PEI) and polyallylamines.

The term ‘tail’ is used in the context of the present invention as a molecular part that is long on a molecular level and wherein the function is primarily derived from its extension rather than the presence of specific functional groups. The tail is suitably compatible with the carrier liquid. More preferably, the tail of the spacer agent is a polymer comprising a plurality of repetitive units with a weight-average molecular weight of less than 5.000 g/mol, preferably in the range of 800-4.000 g/mol.

Suitably, the tail is based on a monomer compound comprising a carbon chain with at least one side chain. The monomer compound may contain an alkyl or alkylene group and optionally a carboxylic linking group. The carboxylic linking group is suitably an ester group. The alkyl- and alkylene chains are for instance prepared by combining saturated or unsaturated fatty acid, for instance C8-C26 fatty acids. Good results have been obtained with C16-C20 fatty acids, such as poly(hydroxy stearic acid) and poly(hydroxyricinoleic acid). More preferably, such polymers have a weight-average molecular weight in the range of 1.200-3.600 g/mol. Alternatively, use can be made of olefin, suitably based on a branched repetitive unit, such as isobutylene. The resulting polyolefin suitably has an average molecular weight in the range of 800-2.500 g/mol.

The stabilising groups of the dispersing agent are suitably chosen from the groups of fatty acid compounds and polyolefins, but similar groups are not excluded. The fatty acid compounds are for instance hydroxylated, and may be polymerized. Preferred examples of the stabilising groups and the dispersing agent in its entirety have been described in Applicants' non-prepublished patent applications NL2011955 and NL2012086, which are herein included by reference. Alternatively, use may be made of commercially available dispersing agent, such as Solsperse™ 13940, Solsperse™ 11000, which again combine a polyamine anchor group with polymeric stabilising groups.

The spacer agent may be added to the liquid toner dispersion and/or to the excess liquid toner dispersion. It will be initially dissolved in the carrier liquid, but may thereafter interact or even react with the dispersing agent or the toner surface. Such interaction generally does not preclude its state of being dissolved, though the term ‘dissolved’ may not be appropriate anymore when seen at the microscopic level.

Suitably, the excess liquid toner dispersion is recycled into fresh liquid toner dispersion, such that any addition of spacer agent to the excess dispersion effectively constitutes an addition to the fresh dispersion. The addition of spacer agent may occur during preparation (to the concentrate of the liquid dispersion), in the course of dilution of said concentrate in a printing machine or during the printing process, for instance by means of a roller that interacts with the first member. In case that addition of the spacer agent in the machine is foreseen, a separate tank for the spacer agent is suitably provided. More preferably, in such case, the spacer agent is added in the form of a solution in a carrier liquid. The spacer agent can also be added in combination with a dispersion agent as well in all situations mentioned above.

The spacer agent is suitably, in a first embodiment, present in the liquid toner dispersion in an amount of at most 5 wt % relative to the amount of marking particles. Preferably, the spacer agent is present in an amount in the range of 0.05-5%, more preferably 0.1-3.5% and most preferably 0.2-2% relative to the amount of marking particles. The liquid toner dispersion is herein defined as the initial dispersion that is fed via a feed member to a development member, as will be further explained with reference to FIG. 1.

Alternatively, the spacer agent may be added in higher concentrations, for instance up to 12.5 wt % of the marking particles, for instance in the range of 2-8 wt %. It was found that the provision of the spacer agent in higher concentrations strongly improves the caking behaviour of an excess liquid toner dispersion, i.e. the dispersion remaining on the development member after patternwise transfer of the liquid toner dispersion to the imaging member. Furthermore and again surprisingly, it was found that the conductivity of the liquid toner dispersion increased less than expected. The increase in conductivity was less than proportional to the increase in concentration of the spacer agent. Moreover, and notwithstanding the higher concentration of the spacer agent than in the first embodiment, the liquid toner dispersion turns out to have proper fusing behaviour as defined in a hotplate test. This behaviour is understood by the inventors to be due to binding of the spacer agent to dispersing agent that is anchored on the surface of marking particles. In this way, the spacer agent functions as a surface modification, and aims at enhancing the dispersing ability of the marking particles.

These and other aspects will be further discussed with reference to the figure and examples. It is observed for clarity that any aspect or dependent claim in relation to one aspect is also applicable in relation to another aspect of the invention.

### BRIEF DESCRIPTION OF THE FIGURES

These and other aspects of the invention will be further elucidated with reference to the figures, which are diagrammatical in nature and not drawn to scale and wherein:

FIG. 1 is a schematic view illustrating a first embodiment of the invention.

### DETAILED DISCUSSION OF ILLUSTRATED EMBODIMENTS

The Figures are not drawn to scale and purely diagrammatical in nature. Equal reference numerals in different Figures refer to equal or corresponding features.

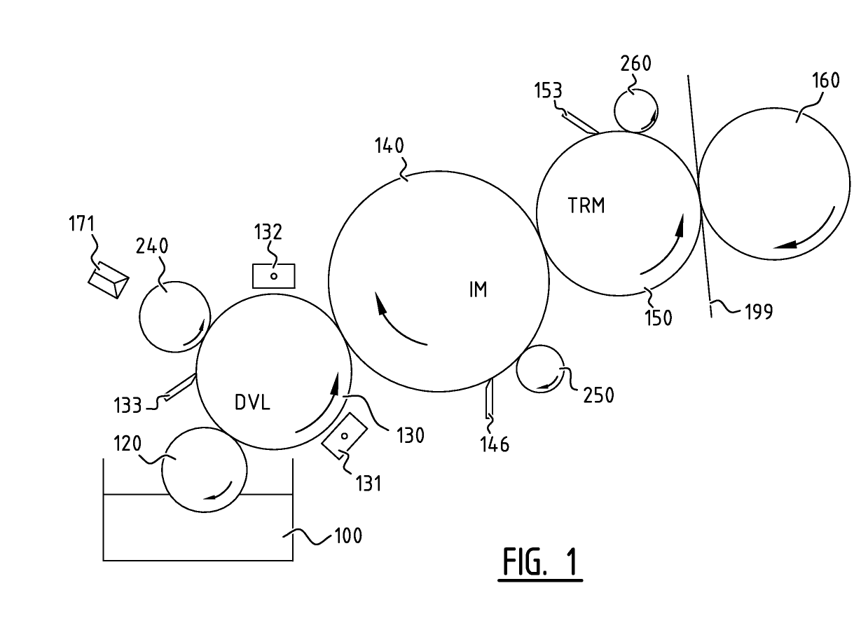

FIG. 1 illustrates diagrammatically a first embodiment of a digital printing apparatus of the invention, comprising a reservoir 100, a feed member 120, a toner member 130, an imaging member 140, an intermediate member 150 and a support member 160. A substrate 199 is transported between intermediate member 150 and support member 160. Both the development member 130 and the imaging member 140 and also the intermediate member 150 can function as the first member according to the invention, and are shown to be provided with a removal device 133, 146, 153, and with treatment means 132, 240; 250; 260. Without loss of generality, the aforementioned members are illustrated and described as rollers, but the skilled person understands that they can be implemented differently, e.g. as belts.

In operation, an amount of liquid toner dispersion, initially stored in a liquid toner dispersion reservoir 100, also called main reservoir, is applied via a feed member 120, to a development member 130, an imaging member 140, and an optional intermediate member 150, and finally to a substrate 199. The development member 130, imaging member 140, and intermediate member 150 all transfer part of the liquid toner dispersion 100 adhering to their surface to their successor. The part of the liquid toner dispersion 100 that remains present on the member's surface, i.e. the excess liquid toner dispersion, which remains after selective, image-wise transfer, is removed after the transfer stage by appropriate means. The development member 130, the imaging member 140 and the intermediate member 150 may all act as the first member.

The charging of the toner on the development roll is done by charging device 131. This charging device can be a corona or a biased roll. By charging the toner the liquid toner dispersion splits into an inner layer at the surface adjacent of the development member 130 and an outer layer. The inner layer is more rich is marking particles and the outer layer is richer in carrier liquid. The transition between these two layers may be gradual.

Upon transfer of the liquid toner dispersion from the development member 130 to the imaging member 140, excess liquid toner dispersion is left on the development member 130. Ideally, this excess liquid toner dispersion is present only in “non-image” areas, i.e. areas not corresponding to the image to be printed on the substrate, which is specified by the imaging member. However, it is not excluded that a thin layer remains on the development roller 130 at the area of the transferred image. The physicochemical state and the rheology of the excess liquid toner dispersion are influenced by the charging and also by the concentration of the toner particles, which may have changed i.e. increased due to loss of carrier liquid during the development step. More particularly, in one suitable embodiment, the excess liquid toner dispersion is more concentrated and shows caking. This transformation is due to the charging and to the transfer of part of the outer layer that is richer in carrier liquid.

FIG. 1 further shows a discharging corona 132 that is provided downstream of the area of the rotational contact between the toner roller 130 and the imaging roller 140. The discharging corona 132 is suitable for changing/removing the charge in the dispersion. Further, downstream of the discharge corona 132 there is provided an additional member 240. In this example, the additional member is embodied as a loosening roller, which is provided with a rubbing portion. This is useful for improvement of mixing of the excess liquid toner dispersion with the added spacer agent. At this point also other additives can be added such as pure carrier liquid or dispersing agents diluted in carrier liquid in order to reduce the concentration of the compacted toner solution. As shown in this example, but that is not deemed essential, the agent may be applied in a pattern wise manner via application means 171. Such application means 171 may be inkjet printing heads and other disposal means for patterned application of a liquid. In the shown example, the spacer agent may be added to the excess liquid dispersion, pattern wise via the application means 171 and the loosening roller 240. The loosening roller 240 is, in use, in rotational contact with the development member 130. Similar loosening rollers 250, 260, which could be simply addition rollers without a dedicated rubbing portion, are present in rotational contact with the imaging member 140 and the intermediate member 150 respectively. Thereafter, a removal device is present, which most suitably is a scraper 133. The removed material is preferably recycled into fresh liquid toner.

Investigations have shown that several steps in the printing process are sensitive for failure, which may lead to errors in the image printed on the substrate, or to malfunctioning of the printing process.

A first sensitive step is the charging step 131. Marking particles in the dispersion are aligned herein due to the charging and/or the presence of an electric field typically applied at the nip between the first member and the further member, f.i. the toner member 130 and the imaging member 140. Without a proper charging and alignment, the patterned transfer from the first member to the further member will not be adequate. The presence of a spacer agent does not interfere with this process but probably prevents the toner particles of getting too close so the compaction is less irreversible.

A second sensitive step is the fusing of the liquid toner. This fusing is to result in coalescence of the marking particles on the paper. Typically use is made of a heat treatment that takes place shortly before, during or shortly after the transfer of the dispersion to the substrate. The term ‘coalescence’ refers herein to the process wherein marking particles melt and form a film or continuous phase that adheres well to the substrate and that is separated from any carrier liquid. Suitably, the carrier liquid is thereafter removed in a separate step, for instance by means of rollers, by means of blowing off the carrier liquid, by means of suction. Suitably, this process occurs at “high speed”, for instance 50 cm/s or more, so as to enable high-speed printing. The fusing will avoid formation of an emulsion, since an emulsion does not give a good printing image because film formation is omitted. The presence of the spacer agent(s) does not or not significantly interfere with this filming behaviour at elevated temperature.

A third sensitive step is the removal of the liquid toner residue (excess liquid toner dispersion) which remains on the first member in the transfer step to the further member. This first member is preferably the development roller 130, but may alternatively be the imaging member 140 or the intermediate member 150. Particularly, marking particles in the liquid toner dispersion tend to form lumps in the dispersion resulting in a liquid with a non-uniform distribution of marking particles. This is called caking and often results in an increase of the viscosity of the liquid dispersion and partial jelly fractions of ink. This viscosity increase is significant and could be a tenfold increase or even more. The removal of the liquid toner residue starts then to be problematic. As a result, liquid toner residue could remain on the development roller, which constitutes a contamination and may lead to a non-uniform distribution of fresh toner dispersion resulting in a ghost image and or image quality that is not perfect, in other words incorrect. Examples of issues are density instability and incorrect reproduction of fine lines.

In order to solve the caking issue, mechanical and chemical means may be used to clean the surface of the first member 130. The use of chemical means is however relatively limited, because the removed material is suitably recycled into fresh toner. Typically, no additives are allowed which would contaminate the fresh toner and thus have an impact on the printing process and/or the quality of the printed image.

In order to arrive at an improved printing process, the dispersion is a key element, and a difficult one. Modification of the dispersion typically influences its behaviour during charging and fusing. Modification of the dispersion also may have an impact on the behaviour of the liquid toner residue. Particularly, a dispersion that becomes unstable and inhomogeneous can give rise to a tremendous change in the rheology: a homogeneous dispersion mostly flows in its entirely, but the rheology of an inhomogeneous dispersion is in fact dependent on the two separate phases in the dispersion (the dispersed phase and the dispersing phase). In other words, the behaviour of a dispersion that becomes inhomogeneous is highly complex.

In accordance with the invention, the dispersion is modified by addition of the spacer agent having a substantially non-polar tail, and a polar head group. The non-polarity of the tail leads to a good affinity for the non-polar carrier liquid. The polarity of the head group allows interaction with the dispersing agent.

It was found in preliminary experiments that the use of such a spacer agent reduces the viscosity of the excess liquid toner dispersion (also referred to as toner residue), but does not have an impact on the behaviour of the liquid toner during charging and fusing. It herein behaves differently from the dispersing agent, that when added to the liquid toner tends to influence both the fusing behaviour and charging behaviour negatively in a simultaneous way or one of both at a time.

The invention is based on the insight, that the spacer agent probably will be located between marking particles. It is believed that the spacer agent will not, or at least not immediately, adsorb on the marking particles, due to the absence of an anchor group like the ones present in the dispersing agent. This is believed the reason that the spacer agent does not have—at least not significantly—an impact on the behaviour of the liquid toner during charging and/or during fusing:

the spacer agent is only present between the particles and not absorbed irreversibly onto the particles' surface. Rather, because of its affinity for the tails of the dispersing agent, it could be located, at least to a significant extent, between marking particles in the charging step.

The spacer agent is seen to provide an entropic effect. It tends to disrupt or make more difficult any interaction between marking particles. It is believed that this disruption is based on a steric effect, i.e. on an effect of steric hindrance which increases the distance between the particles. A disruption of the structural order (i.e. of the tails of adjacent dispersing agents or tails within the same dispersing agent molecule) may also be relevant.

Preferably, the spacer agent is branched, i.e. contains a carbon-based chain provided with one or more side chains. More preferably, the spacer agent contains any groups that are feasible of interaction with the dispersing agent hydrophobic groups. For instance, the spacer agent could contain groups that are structurally identical or structurally similar to the tails of the dispersing agent. The term ‘structurally similar’ is herein used to express that the agent contains a similar combination and structure of chemical groups. However, the chemical groups need not be identical. For instance, both spacer agent and dispersing agent may contain carboxylic linking groups and alkyl chains, but the carboxylic linking groups could be different (i.e. ester, amide) and also the alkyl chains could be different from each other.

In one further embodiment, the spacer agent, and particularly its tail, is a polymer rather than a monomer, especially if more polar functional groups are present. The number of repeating units is for instance in the range of 2-30, preferably such as 5-10 in the embodiment with fatty acid polymers. This allows for an alternation and repetition of chemical groups with a different character. Such repetition may allow interaction of the spacer agent with a plurality of dispersing agent tails, rather than merely with one such tail. More preferably, the spacer agent is a polymeric alkylester, wherein the alkyl group preferably is C10-C30 alkyl, more preferably C12-C24 alkyl. The alkylic chain is for instance a branched chain provided with one or more alkylic side chains. Alternatively, the spacer agent may be a polyolefine, more preferably a polyolefine based on a branched monomer. Examples include polypropylene, polyisobutylene, copolymers of polyethylene and C3-C6 alkylenes. The weight-average molecular weight of such a polyolefine is suitably in the range of 500-2500 g/mol, preferably 800-1500 g/mol.

A suitable example is for instance a poly-hydroxystearic acid with 4-10 repetitive units. In an alternative example, the spacer agent is a polyol ester. Suitable classes of polyol esters include trimethylolpropane esters, trimethylolpropane diesters, pentaerythritol esters, dipentaerythrithol esters and sorbitane trioleate esters. These esters are for instance based on alkanoic acids and unsaturated alkenonic acids, for instance with chain lengths of C5-C20, for instance C5-C12 for alkanoic acids. For instance, the trimethylolpropane esters may be based on C7-C10 esters, wherein the three alkanoic acid chains may be identical or different.

The spacer agent may be added to the dispersion at any suitable stage of the process. It could be added to the pre-dispersion and be mixed in. It could be added when preparing and conditioning the fresh liquid toner. It could be added before charging. Furthermore, the spacer agent may be added to the excess liquid toner dispersion. Due to the recycling it will then still end up in the liquid toner. A combination of addition steps may be used alternatively.

When adding the spacer agent to the excess liquid toner dispersion, this may be done with an additional member that is in use in rotational contact with the first member. Such additional member may further have a rubbing portion, so as to improve mixing and/or fracturing of caking in the liquid toner residue. The spacer agent may further be added image-wise, i.e. particularly in non-image areas that correspond to the areas outside the image to be printed on the substrate and selectively transferred from the first member to the further member. These features have been described in the non-prepublished applications NL2010581, EP131625774 and NL2011381 in the name of Applicant and are herein included by reference.

Suitably, the spacer agent is present in the liquid toner in an amount of 0.05-3 wt %, relative to the amount of marking particles. The spacer agent is suitably added in the form of a solution in the carrier liquid. The added solution may further contain any dispersing agent, but that is not deemed necessary.

In this invention, when is referred to a concentration of ‘liquid toner dispersion’ it refers to a concentration wherein the liquid toner dispersion has a solid content so that it can be used as such in a digital printing process. In other words, the liquid toner dispersion according to the invention has a solid content that is at working strength and does not require a dilution. A typical solid content of liquid toner dispersion is a solid content of between 10 to 30 wt %, such as a solid content of 25 wt %. According to this invention, “solid content” means the amount of marking particles in wt % with regard to the total liquid toner dispersion. According to this invention, “excess liquid toner dispersion” is the liquid toner dispersion that remains present on the surface of a member, such as the developing member, after a part of liquid toner dispersion has been transferred to another member, such as the imaging member.

In the context of the present invention, the liquid toner is a dispersion of marking particles in a carrier liquid. The marking particles, according to this invention, comprise coloured particles (also called ink particles or pigment) and a binder resin although non-pigmented resin systems also can be used containing a phosphor or taggant or UV active material. Typically, the diameter of the marking particles is about 0.5 to 4.0 μm. The marking particles have a concentration of about 40-95% of binder resin. The binder resin is a polymer, preferably transparent, that embeds the ink particles. Preferably, a polyester resin is used as binder resin. Also other types of resin having a very low or no compatibility with the carrier liquid and dispersing agent can be used. Preferably, the resin has a high transparency, provides good colour developing properties and has a high fixing property on the substrate. The carrier liquid according to the invention can be any suitable liquid as is known in the art and may be silicone fluids, hydrocarbon liquids and vegetable oils, or any combination thereof.

In the liquid toner dispersion of the invention, the dispersing agent is—at least partly—bound to the marking particles, either chemically or physically. Additional ‘free’ dispersing agent may be present in the dispersion, but its concentration is suitably low. The pigment is typically melt mixed with the binding resin and optional other ingredients such as waxes, plasticizers and charging additives into a pre-dispersion. The melt mixing preferably is carried out by means of extrusion to form the marking particle. Thereafter, the marking particle is treated to provide suitably dimensions, for instance by dry milling. The marking particles are then mixed with carrier liquid and dispersing agent into the liquid pre-dispersion, which is thereafter further processed, for instance by fluid milling like bead milling. It is added for sake of clarity that a wax—such as cetyl palmitate—is distinct from the present spacer agent. Such a wax is typically added as a compound for arranging the melt viscosity of the toner resin, as stated in the non-prepublished application EP12186676.8 in the name of Applicant.

The concentration of marking particles (solid content) in the excess liquid toner dispersion will vary depending on the amount of marking particles that need to be developed. The two most extreme situations of developing are that all the liquid toner dispersion is developed (100% page coverage), or none of the liquid toner dispersion is developed (0% page coverage). The latter results in a substrate without printed image of that colour. When no liquid toner dispersion is developed and all the marking particles remain on the developing member and thus reside in the excess liquid toner dispersion, the solid content is higher than in the liquid toner dispersion, particularly due to the partial removal of the carrier liquid containing some dispersing agent in the non-image areas. On the contrary, if all the liquid toner dispersion is developed, the excess liquid toner dispersion remaining on the toner roller will comprise almost no marking particles resulting in an excess liquid toner dispersion that mainly comprises carrier liquid containing also some dispersing agent. A person skilled in the art will understand that the solid content and the concentration of the carrier liquid in the excess liquid toner dispersion will vary between these two extremes depending on what needs to be developed. Typically, during the printing process a certain amount of carrier liquid is lost because it is highly unlikely that one prints continuously 100% page coverage all the time for all colours. Typically, the viscosity of the excess liquid developing dispersion is increased compared to the viscosity of the starting, i.e. ‘fresh’ liquid developing dispersion. The increase of the viscosity is due to the loss of carrier liquid and dispersing agent and due to caking. Caking causes a structural change in the liquid developing dispersion and has a significant contribution to the increase of viscosity of the excess liquid toner dispersion.

For sake of completeness, it is observed that U52007/0258731 discloses a preparation method for a liquid developer dispersion, wherein pigment and binder resin is mixed with a first carrier liquid to form marking particles. The resulting marking particles are dispersed with a conventional dispersing agent such as Solsperse™ 13940 into a second carrier liquid. The Solsperse™ 13940 is a dispersing agent of the hyper-dispersant type with an anchoring group to which a plurality of stabilising groups is attached. It has a significant molecular weight, in the range of 20,000-80,000. The anchoring group will adhere to the surface of the marking particles, with the stabilising groups extending into the carrier liquid. In the said application, the first carrier liquid is a fatty acid monoester, such as the alkyl monoester of unsaturated or saturated fatty acids, such as oleic acid, palmitoleic acid, butyric acid, stearic acid. The second carrier liquid is an (un-)saturated fatty acid triglyceride, typically with a number of carbon atoms in the fatty acid in the range of 6 to 22. Upon heating, particularly during a fusing process the first and second carrier liquid may be cured together. This known liquid developer dispersion however does not contain a spacer agent, since the fatty acid monoester does not have the ability to interact with the dispersing agent, nor is it suitable for having a spacer function. In fact, the monoester is not a polar head and the molecule is not sufficiently big to have a spacer function.

Moreover, rather than a carrier liquid, the spacer agent is an additive to the liquid dispersion of the invention. The spacer agent is suitably present in a weight ratio of at most 200 wt % of the dispersing agent composition, preferably at most 100 wt % and suitably at most 50 wt %. The dispersing agent composition herein comprises approximately 30-50% and for instance 40 wt % of dispersing agent.

### EXAMPLES

### Effect of Spacer Particles on Conductivity and Caking Level of the Liquid Toner Dispersion

### Test System

As there are no standard measurement tools for caking as encountered in a liquid toner electrophotographic process, a test system was built consisting of a simplified version of the apparatus described in FIG. 2. The system comprises a liquid toner dispersion reservoir, a toner supply roller, a development roller, a thickening corona for toner compaction on the development roller and a polyurethane scraper blade to remove excess toner from the development roller. As the test system has no photoconductor, all toner applied to the development member is considered excess toner. Hence this test system makes it possible to perform worst-case caking experiments.

An anilox roller with a volume of 14 cm³/m² was used and the rubber of the development roller is a silicone rubber with a hardness 50 shore A. The test system was operated at 60 cm/s and the thickening corona was operated at 4 kV.

The caking level is evaluated by visual inspection of the toner on the scraper blade and ranked as follows:

0 refers to no caking, meaning that a very good result is obtained.
1, 2, or 3 refers to caking levels where small acceptable amounts of caking occurs, where 1 refers to a good result, 2 refers to a moderate result, and 3 refers to a result that is just acceptable.
4 refers to a caking level that is not acceptable.
5 refers to severe caking.

### Conductivity Measurement

The conductivity is measured with a device as described in the patent application with number EP1120647 filed in the name of the applicant, where the device has an electric field strength of 1.25×10⁶ V/m.

### Hot Plate

One drop of the liquid toner dispersion is put on a hot plate of Kapton™ (polyimide tape supplied from 3M) at 150° C. The coalescence is observed and the coalescence time measured. This test is defined for simulating the fusing process during printing. The speed of collapsing into a marking particle phase and a carrier liquid phase is found to be representative for the printing process. The hotplate test is ok, if the collapsing into two phases occurs within 60 seconds.

### Ranking

1: clear carrier liquid and separation time less than 30 sec: very good
2: slightly coloured carrier liquid and separation time less than 30 sec acceptable
3: slightly coloured carrier liquid and separation time more than 60 sec-not acceptable
4: coloured carrier liquid and separation time more than 60 sec-very bad

### Viscosity

The viscosity of the liquid toner dispersion and carrier liquid is measured with a Haake Rheostress RS6000 operated in shear rate sweep from 0.1 to 3000 l/s at 25° C.

The instrument is equipped with a cone/plate geometry type C60/1° and the gap is set to 0.052 mm.

### Liquid Toner Dispersion

A liquid toner dispersion comprising a marking particle, a carrier liquid and a dispersing agent is prepared. The ingredients used to prepare the marking particles and the liquid toner dispersions are summarized in table 1.

TABLE 1
ingredients

| | Name | Description |
|---|---|---|
| Polymer | PM1 | polyester resin with an acid value of 12 mg KOH/g, |
| | | a Tg of 60° C. (1) and a Tm of 99.8° C. (1) |
| Additive | AD1 | Toluene sulphonamide |
| Pigment | PIG1 | Heliogen Blau D7079 |
| Dispersing | DA1 | polymeric dispersing agents with a polyethylenimine |
| Agent | | backbone and polyhydroxystearate grafts having a |
| | | base equivalent (2) of 560-620 |
| Liquid | LIQ1 | mineral oil having a viscosity of 5 mPas measured at |
| | | 1 Hz at 25° C. and a conductivity of 0.2 pS/cm |

measured according to ASTM D3418
the amount of dispersing agent that is needed to neutralize 1 mol of acid

Table 2 shows the composition of the marking particles. The marking particles are prepared by kneading the ingredients of table 2 at a temperature of 100 to 120° C. for 45 minutes. This mixture is cooled down and milled down to obtain particles with a size of about 10 μm using a fluidised bed mill.

TABLE 2
Composition of marking particles

| | | conc | | conc | | conc |
|---|---|---|---|---|---|---|
| | Polymer | (w/w | Pigment | (w/w | Additive | (w/w |
| name | name | %) | name | %) | name | %) |
| MAR1 | PM1 | 81.5 | PIG1 | 12.5 | AD1 | 6 |

Afterwards a liquid toner dispersion having the composition as indicated in table 3 is prepared. A pre-dispersion of the ingredients is made and stirred for 10 min at room temperature. The pre-dispersion is brought into a liquid milling device. The liquid toner dispersion is milled down to a dv50 of 1.5 to 2.5 μm with a bead mill. The milling was done until the desired particle size, viscosity and conductivity was obtained.

TABLE 3
liquid toner dispersion composition

| | Marking Particles | | Dispersing Agent | | Carrier Liquid | |
|---|---|---|---|---|---|---|
| | | conc | | conc | | conc |
| name | name | (w/w %) | name | (w/w %) | name | (w/w %) |
| LD1 | MAR1 | 35 | DA1 | 3.5 | LIQ1 | 61.5 |

### Results

The inventors performed a printing test using liquid toner LD1 in a diluted form, having a solid content (SC) of 25% in the test system as described above. The spacer agent was added to the diluted liquid toner dispersion at the moment of dilution. Several concentrations and types of spacer agents were tested as depicted in table 4. Table 4 shows the caking of the excess liquid toner dispersion comprising the spacer agents using the test system as described above.

TABLE 4
caking results

| | | conc. spacer | | | |
|---|---|---|---|---|---|
| | | (wt % relative | | | |
| | spacer | to marking | conductivity | caking | |
| Example | type | particles) | (pS/cm) | level | hotplate |
| comp(1) | No | — | 1.1 | 5 | 1 |
| comp(2) | DA1 | 0.8 | 8.2 | 3 | 3 |
| 1 | PHSA(1) | 0.8 | 2.3 | 2 | 2 |
| 2 | PHSA(2) | 0.5 | 1.7 | 3 | 2 |
| 3 | PHOA | 0.8 | 2.2 | 2 | 2 |
| 4 | PIBSA | 0.3 | 3.01 | 3 | 2 |
| 5 | PHSA(1) | 2 | 3.8 | 1 | 2 |
| 6 | PHSA(1) | 5 | 5.2 | 1 | 2 |

Herein, PHSA (1) refers to polyhydroxystearic acid with moleculair weight of 2,200 g/mol. PHSA (2) refers to polyhydroxystearic acid with moleculair weight of 2,800 g/mol. PHOA refers to polyhydroxyricinoleic acid with molecular weight of 2,500 g/mol. PIBSA refers to polyisobutylene succinic anhydride with molecular weight of 1,000 g/mol.

The results in Table 4 show the addition of the spacer agent reduces caking. This is clear from the comparison of the examples 1-4 with comparative example 1 (comp. (1)). Furthermore, it can be observed that the toner conductivity does not change significantly, indicating that the electrophotographic properties are not adversely affected by the presence of the spacer agent. The hotplate results are acceptable so demonstrating that the addition of the spacer agent does not have a negative impact on the fusing properties. On the contrary, if extra dispersing agent is added, as shown in comparative example 2 (comp(2)), the caking is improved but the hotplate becomes unacceptable indicating an bad fusing. Even when the concentrations of addition of spacer agent are as high as 5% relative to the marking particles (ex 5 and 6), the increase in conductivity is moderate so that the electrophotographic properties are not adversely affected and caking is further improved without having a negative impact on the fusing. This moderate increase is quite surprising. As follows from comparison of the examples comp(1), 1, 5 and 6, the conductivity increases from 1.1 to 2.3 pS/cm upon addition of 0.8 wt % spacer. However, when adding 2 wt % spacer (150% extra), the conductivity increases to 3.8 pS/cm (125% extra). And when adding to 5 wt % spacer (500% extra), the conductivity increases to 5.2 (240% extra).

Thus, in short, the invention provides the use of a spacer agent with a molecular weight of at least 800 g/mol and having a polar head group and a substantially non-polar tail, more preferably in the form of an oligomer. The oligomer is suitably based on a repetitive unit including branching (a side-chain). A most preferred option for the repetitive unit is a hydroxylated fatty acid, more particularly wherein the hydroxylation is in the middle of the chain, for instance between position 5-14 so as to create the branching. The polar head is more particularly an acid, anhydride or amide.

This set up is suitable for interaction with dispersing agents of the hyper-dispersant type comprising a plurality of stabilising groups. The addition of such a spacer agent, typically in the concentration of 0.05-12.5 wt % with respect to the marking particles, and suitably in an amount less than that of the dispersing agent, more preferably even at most 50 wt % or at most 25 wt % or even at most 15 wt % relative to the dispersing agent, turns out to be beneficial for the flow properties of key portions of a printing process with a liquid developer dispersion, particularly with respect to caking of the excess liquid developer dispersion remaining behind on particularly the development member and of fusing of the liquid developer dispersion that has been transferred to the substrate.

1. Liquid toner dispersion comprising marking particles to which dispersing agent is bound for dispersing said marking particles in a substantially non-polar carrier liquid, which dispersing agent is of a hyper-dispersant type comprising an anchor group for binding to a marking particle and stabilizing groups coupled to said anchor group for stabilizing said marking particle in the carrier liquid, wherein the dispersion further comprises a spacer agent that comprises a polar head group and a substantially non-polar tail, and that acts as a spacer of the marking particles, and wherein the spacer agent has a molecular weight of at least 800 g/mol.

2. The liquid toner dispersion as claimed in claim 1, wherein the spacer agent has a molecular weight of at least 1000 g/mol.

3. The liquid toner dispersion as claimed in claim 1, wherein said spacer agent acts as a spacer of marking particles in an excess liquid toner dispersion that is obtainable from said liquid toner dispersion by a charging treatment and subsequent selective transfer of the dispersion or portions thereof from a first member to a further member, wherein the excess liquid toner dispersion remains present on the first member.

4. The liquid toner dispersion as claimed in claim 1, wherein the polar head group of the spacer agent is chosen from the group consisting of acids, anhydrides and amides.

5. The liquid toner dispersion as claimed in claim 1, wherein the spacer agent is structurally branched.

6. The liquid toner dispersion as claimed in claim 5, wherein the tail of the spacer agent has a carbon-based chain provided with one or more side-chains.

7. The liquid toner dispersion as claimed in claim 5, wherein the tail of the spacer agent is a polymer comprising a plurality of repetitive units and wherein the spacer agent has a weight average molecular weight of less than 5000 g/mol.

8. The liquid toner dispersion as claimed in claim 7, wherein the spacer agent has a weight-average molecular weight in the range of 1000-4000 g/mol.

9. The liquid toner dispersion as claimed in claim 7, wherein each repetitive unit of the polymer comprises a chemical group suitable for interaction with the stabilizing group of said dispersing agent, which extends into the carrier liquid.

10. The liquid toner dispersion as claimed in claim 7, wherein the repetitive unit comprises an aliphatic ester.

11. The liquid toner dispersion as claimed in claim 1, wherein the spacer agent is a fatty acid polymer.

12. The liquid toner dispersion as claimed in claim 11, wherein the fatty acid polymer has a weight-average molecular weight in the range of 1000-3600 g/mol

13. The liquid toner dispersion as claimed in claim 12, wherein the fatty acid polymer has a weight-average molecular weight in the range of 1800-3600 g/mol.

14. The liquid toner dispersion as claimed in claim 1, wherein the spacer agent is present in an amount less than 12.5 wt % relative to the amount of marking particles.

15. The liquid toner dispersion as claimed in claim 14, wherein the spacer agent is present in an amount of 2-8 wt % relative to the amount of marking particles.

16. The liquid toner dispersion as claimed in claim 1, wherein the tail of the spacer agent is a branched polyolefin.

17. Method of digitally printing comprising the steps of:
charging a liquid toner dispersion comprising marking particles to which dispersing agent is bound for dispersing said marking particles in a substantially non-polar carrier liquid, which dispersing agent is of a hyper-dispersant type comprising an anchor group for binding to a marking particle and stabilizing groups coupled to said anchor group for stabilizing said marking particle in the carrier liquid;
transferring the charged liquid toner dispersion imagewise from a first member optionally via at least one further member to a substrate, wherein excess liquid toner dispersion remains present on the first member after said imagewise transfer;
removing, at least substantially, the excess liquid toner dispersion from the first member, wherein a spacer agent is present that comprises a polar head group and a substantially non-polar tail, and that acts as a spacer of the marking particles, and wherein the spacer agent has a molecular weight of at least 800 g/mol.

18. The method as claimed in claim 17, wherein the spacer agent is added to the liquid toner dispersion or to the excess liquid toner dispersion.

19. The method as claimed in claim 17, wherein the polar head group of the spacer agent is chosen from the group consisting of acids, anhydrides and amides.

20. A method of printing comprising:
charging a liquid toner dispersion comprising marking particles and a space agent; and
transferring the charged liquid toner dispersion imagewise from a first member to a substrate, wherein the space agent acts in spacing apart the marking particles, the space agent comprising a polar head group and a substantially non-polar tail and a molecular weight of at least 800 g/mol.
